(19) United States
(12) Patent Application Publication
(10) Pub. No.: US 2022/0136722 A1
(43) Pub. Date: May 5, 2022

(54) SOFTWARE-DEFINED MASTER SYSTEM FOR SMART BUILDINGS

(71) Applicant: Schneider Electric Buildings, LLC, Rockford, IL (US)

(72) Inventors: Mayank SHARMA, Grenoble (FR); Hubert Thompson LINDSAY, Victoria (CA)

(73) Assignee: Schneider Electric Buildings, LLC, Rockford, IL (US)

(21) Appl. No.: 17/519,342

(22) Filed: Nov. 4, 2021

Related U.S. Application Data
(60) Provisional application No. 63/110,250, filed on Nov. 5, 2020.

(51) Int. Cl. F24F 11/46; G05B 19/042; F24F 11/63

(52) U.S. Cl. CPC F24F 11/46; G05B 2219/2614; F24F 11/63; G05B 19/0421

(57) ABSTRACT

System and method for designing and deploying a building-related service in a building automation management system (BAMS) based on a software-defined master system (SDMS) architecture. The master system of the BAMS comprising a plurality of building automation systems (BASs) receives a request to create a building-related service involving dynamic coordination between at least two BASs. The request may include a workflow comprising a set of actions and configurations defining the building-related service. The master system uses system description data generated from the workflow to instantiate a blueprint that defines data exchanges with the at least two BASs, information about target hosts, and any dependencies to be resolved. Upon parsing the blueprint to resolve any dependencies, the master system builds a deployment plan that includes a sequence of steps and configurations for implementing the building-related service. The master system

[symbol]

### CROSS-REFERENCE TO RELATED APPLICATION(S)

This application claims priority to and benefit from U.S. Provisional Patent Application Ser. No. 63/110,250 filed on Nov. 5, 2020, the content of which is hereby incorporated by reference in its entirety herein.

### TECHNICAL FIELD

This application generally relates to building management systems and smart buildings and more particularly to a building management system for a smart building based on a software-defined master system (“SDMS”).

### BACKGROUND

A building management system (BMS) or Building automation system (BAS) is an intelligent computer-based system operating a dedicated BMS software to monitor and/or control various building sub-systems such as heating, venting and air conditioning (HVAC), lighting and access control. Specifically, the BMS monitors and controls the operation of sensors, actuators and/or other devices or equipment (e.g., IoT devices) of respective sub-systems to ensure safe and efficient operation of the building. For example, a BMS can be connected to a building's HVAC sub-system to monitor and maintain temperature at a desired set point.

### SUMMARY

In one embodiment, a method of implementing a building-related service in a building automation management system (BAMS) comprising a plurality of building automation systems (BASs) is disclosed. The method includes receiving a request to create a building-related service involving dynamic coordination between at least two BASs. The request may include a workflow comprising a set of actions and configurations defining the building-related service. The method further includes generating, from the workflow, system description data and instantiating, from the system description data, a blueprint for the building-related service. The blueprint may define data exchanges with the at least two BASs, information about target hosts, and any dependencies to be resolved. The method also includes parsing the blueprint to resolve any dependencies, building a deployment plan that includes a sequence of steps and configurations for implementing the building-related service, and executing the deployment plan to implement the building-related service.

In another embodiment, a building automation management system (BAMS), comprising a master system, a plurality of building automation systems (BASs), and a set of APIs and/or gateways for connecting the master system with each of the plurality of BASs is disclosed. The master system may further comprise a master system orchestration module executing on one or more machines and configured to: receive a blueprint associated with a building-related service defined by a user. The building-related service may involve dynamic coordination between at least two BASs facilitated by one or more APIs and/or gateways. The blueprint may define data exchanges with the at least two BASs, information about target hosts, and any dependencies to be resolved. The master system orchestration module may further parse the blueprint to resolve any dependencies and build a deployment plan comprising a sequence of steps and configurations for implementing the building-related service. The master system may further comprise a master system coordinator service executing on one or more machines and configured to: execute the deployment plan to implement the building-related service. The execution involving coordination between the at least two BASs facilitated by the master system.

In yet another embodiment, a non-transitory computer-readable medium storing one or more programs comprising instructions which when executed by one or more machines is disclosed. The instructions cause the one or more machines to receive a request to create a building-related service involving dynamic coordination between at least two BASs. The request may include a workflow comprising a set of actions and configurations defining the building-related service. The instructions further include generating, from the workflow, system description data and instantiating, from the system description data, a blueprint for the building-related service. The blueprint may define data exchanges with the at least two BASs, information about target hosts, and any dependencies to be resolved. The instructions may further include parsing the blueprint to resolve any dependencies, building a deployment plan that includes a sequence of steps and configurations for implementing the building-related service, and executing the deployment plan to implement the building-related service.

Other embodiments and implementations are disclosed and each of the embodiments can be used alone or together in combination. Additional features and advantages of the disclosed embodiments are described in, and will be apparent from the following Detailed Description and the figures.

### BRIEF DESCRIPTION OF THE DRAWINGS

FIGS. 1A and 1B are block diagrams of a building automation management system (“BAMS”) comprising a software-defined master system (SDMS) in accordance with some embodiments.

FIG. 2 is a block diagram detailing the logical architecture of the BAMS in accordance with some embodiments.

FIGS. 3A and 3B are logical flow diagrams illustrating a building-related service deployment flow in the BAMS in accordance with some embodiments.

FIG. 4 is a diagram illustrating service dependencies in the BAMS in accordance with some embodiments.

FIG. 5 is a data flow diagram illustrating flow of information through the BAMS to provide integrated scheduling for implementing an effortless entry/exit system in accordance with some embodiments.

FIGS. 6 and 7 includes graphs illustrating details of a room (box) reservation associated with scheduling and coordination aspects for providing access to a building in accordance with some embodiments.

FIG. 8 is a data flow diagram illustrating flow of information through the BAMS to manage demand response while optimizing occupant comfort in accordance with some embodiments.

FIG. 9 is a logical flow diagram illustrating a method of implementing a building-related service in a BAMS in accordance with some embodiments.

FIG. 10 is a functional block diagram of a general-purpose computer system that may be used to implement various embodiments of this disclosure.

FIG. 11 is a functional block diagram of a general-purpose storage system that may be used to implement various embodiments of this disclosure.

### DETAILED DESCRIPTION

In a typical building environment, building management sub-systems such as HVAC, lighting, security, etc., vary not only in function but also age, with newer devices having more capabilities than legacy devices. Moreover, equipment and control systems relating to these sub-systems may be manufactured or developed by different manufacturers and may use different protocols. The task of integrating these disparate sub-systems is therefore often very complex and costly. Moreover, system integrators are needed to deploy and configure the overall system. Because of these and other difficulties, existing building management systems typically support integration of only a small number of sub-systems, typically manufactured by the same manufacturer.

Another disadvantage of existing building management systems is the lack of flexibility. Once a building management system is deployed, it is often not possible to quickly adapt the system or have the system automatically respond to changes. For example, in order to integrate a new sub-system to the building management system, significant configuration and software modification is typically needed. Similarly, if a new functionality becomes available from a managed building management sub-system, or an application requirement evolves, it is not possible to implement these changes without the help of skilled integrators. Thus, even minor reconfiguring or adapting of the building management system inevitably becomes another costly integration project.

Yet another disadvantage of the existing building management systems is the lack of native integration among the sub-systems to support design and deployment of a wide variety of building-related services, particularly building-related services for optimizing the operation of a building as a whole in a vendor agnostic manner. Such building-related services require coordination between two or more sub-systems and/or between the sub-system(s) and one or more external systems. In existing building management systems, any building-related service designed to solve a specific problem that involves two or more building sub-systems necessitates hiring of system integrators skilled in both sub-systems to develop and deploy the solution. If a building operator wants to solve a different problem involving the same two sub-systems or other systems, another custom solution must be developed.

The present disclosure describes various embodiments and implementations of a Building Automation Management System (BAMS). The BAMS, as described herein, is based on a Software Defined Master System (SDMS) architecture to overcome these and other drawbacks of the existing building management systems. The SDMS is a flexible, dynamically configurable, rapidly reconfigurable and scalable system that can be deployed, operated and maintained in a cost-effective manner. The SDMS architecture enables a user (e.g., a building operator) to dynamically design and deploy a new building-related service and/or reconfigure and deploy a previously deployed building-related service that requires a coordinated operation of multiple building sub-systems in a vendor agnostic manner.

The SDMS includes software, services and application programming interfaces (APIs) to simplify the complexity of the BAMS and improve the interoperability of underlying building sub-systems thereby enabling a building operator, who does not necessarily have expertise on the various building sub-systems, to create and deploy building related services in real-time or near real-time. Furthermore, the system and methods disclosed herein improve efficiency by simplifying the design process and performing deployment in an automated manner. For example, users who design the building-related services need not have expert knowledge of the underlying sub-systems (i.e., BAS) or be concerned with the deployment process. The BAMS of the present disclosure can dynamically generate, from the user provided workflow and configuration information, a deployment plan and execute it. By eliminating the manual steps and the need for expert knowledge of underlying sub-systems, the system and methods disclosed herein provides a faster, simpler, fully automated, more accurate, and on-demand design and deployment of building-related services. The BAMS and the SDMS will now be described in detail.

### 1. Definitions

A smart building uses connected devices such as sensors as well as software, which may be embedded in the connected devices and/or or reside in the edge or cloud, to monitor various aspects of the building, and uses the data to make or enable others to make intelligent decisions regarding the building's environment and operations. For example, a smart building can have humidity sensors installed in the interior spaces to monitor humidity levels and a building management system for the smart building can use the humidity data to detect when the indoor relative humidity falls outside of an optimal range and adjust (e.g., turn on or off) the operation of a humidification/dehumidification equipment.

A building-related service is a software program that can be implemented as an application or a service that interacts with one or more building sub-systems associated with a building to monitor, control, optimize and/or manage the building or aspects thereof. A building-related service may be a combination of two or more services, a set of actions/events (e.g., an API calls), or a combination thereof. Non-limiting examples of a building-related service may include a service for performing remote diagnostics and/or maintenance of equipment, a service to integrate new devices, or update existing ones during system expansion or evolutions respectively, a service for energy management, a service for demand response management, a service for managing visitor access to a building and/or the like.

A component, as used herein, belongs to an electrical network, communication network and/or an automation system and is chosen among an asset, a service and a host.

A resource corresponds to information that is produced or consumed by a component. A resource can be accessed in a read mode, in which the resource is read by the component, and/or in a write mode, in which the resource can be generated and stored.

A relationship, as used herein, is indicative of a physical connection between two components or allocation of a resource. A relationship can correspond to a physical connection between two components by declaring a connection from one component to another. A connection indicates that the two components are adapted to communicate with one another. A relationship can correspond to a resource allocation, for instance, by mapping services to one or several specified hosts.

An asset, as used herein, is generally a component with a significant commercial value. In a building environment, an asset may include HVAC equipment, elevators and lifts, fire safety system, captive power plant equipment and associated electrical switchgear etc. Similarly, in an industrial environment (e.g., industrial automation system), an asset may include industrial controllers such as programmable logic controllers (PLCs) and field devices such as sensors and actuators, among others.

A host is adapted to provide computing capabilities to the automation system. A host may be one or more processors on which a program or file is executed, a machine or hardware component such as a programmable logic controller (PLC), a protection relay, or an industrial grade server (Industrial PC). A host can also be a software component such as a virtual machine, a container, a cloud-based service (e.g., Infrastructure as a Service (IaaS) or Platform as a Service (PaaS)) and/or the like that run on a machine or a collection of machines.

An automation system may be fully described by a plurality of components (i.e., assets, hosts, and/or services) linked together by relationships.

### 2. Building Automation Management System (“BAMS”)

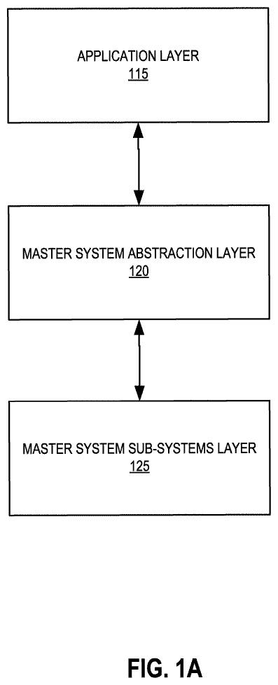

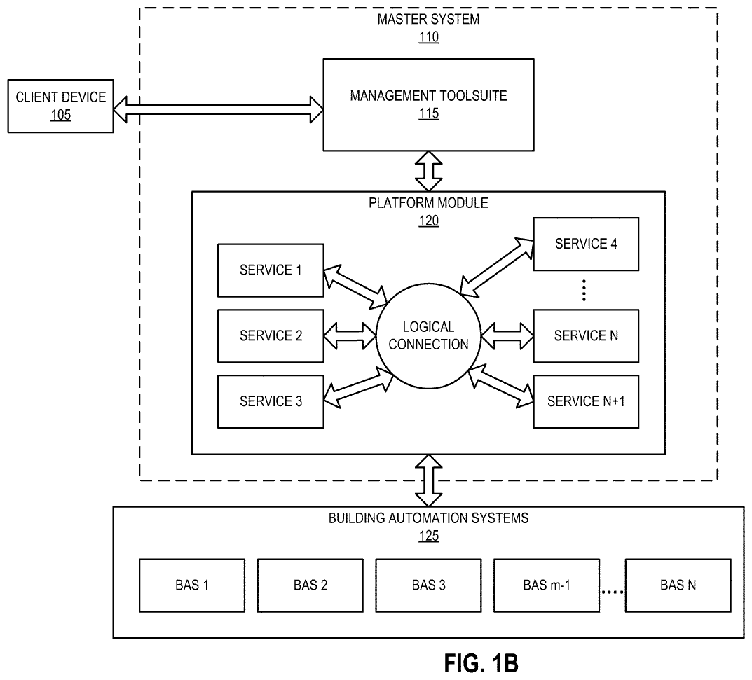

FIG. 1A is a block diagram illustrating the three main layers comprising the BAMS based on the SDMS architecture. The three layers include an application layer 115, a sub-systems layer 125 and a master system abstraction layer 120. The sub-systems layer 125 may comprise a mix of Internet of Things (IoT) ready sub-systems, legacy sub-systems and/or software-defined sub-systems (i.e., BASs). These sub-systems may interact with building applications or services through the abstraction layer 120 of the master system via a set of APIs or physical gateways. The master system abstraction layer 120 provides a logical separation of user and application space from the underlying physical infrastructure. This separation is enabled by applying abstraction, virtualization and/or orchestration technologies. The application layer 115 provides tool suites and digital platforms to enable users (e.g., system integrators) to build and deploy building applications/services (hereinafter “building-related services”) spanning one or more sub-systems of the sub-systems layer 125.

In addition to enabling building operators to dynamically design and deploy building-related services, the SDMS also enables reconfiguring of previously deployed building-related services. Execution of at least some building-related services may require a coordinated operation of multiple BASs in a vendor agnostic manner.

FIG. 1B is a block diagram of the BAMS based on the SDMS architecture in accordance with some embodiments. The BAMS may comprise a master system 110, and a plurality of automation systems associated with a building referred to as building automation systems (BASs) 125 (or building sub-systems). The user space may comprise a client device 105 such as a computer, a tablet, a mobile device, and the like. Non-limiting examples of a BAS include: Heating Ventilation Air-conditioning and Cooling (HVAC), Power Management System (PMS), Energy Management System (EMS), Microgrid, Lighting Control System (LCS), Emergency LCS (ELCS), Electronic Access Control System (EACS), Security Alarm System (SAS), Closed Circuit Television (CCTV) System, Intercom System (IS), Fire and Evacuation Monitoring System (FEMS), Hydraulic Monitoring System (HMS), Irrigation Control System (ICS), Vertical Transport Monitoring System (VTMS), Digital Directory Board, Car Park Management System (CPMS), Waste Management Monitoring Systems, Electronic Key Cabinets, and/or the like. In some embodiments, the plurality of BASs may include external services or systems such as but not limited to: services relating to weather, metro/bus schedule, planned detours and audio/visual systems. Each BAS comprises of a plurality of automation components, hereafter referred to as automation devices or hosts. Hosts may be stand alone or connected with one or several assets of the building.

A plurality of client devices (e.g., 105) may interact with the master system 110 via a management tool suite 115. The management tool suite 115 may be considered a part of the master system 110 and is in communication with a master system platform module 120 of the master system 110. The master system platform module 120 may comprise a plurality of master system services (e.g., services 1 . . . N+1) to monitor and/or control a plurality of BASs 125. By way of example only, these services may include runtime services relating to control, scheduling, monitoring, actuation, and the like. The plurality of master system services may also include other services necessary to provide connectivity, security, and the like, and provision, commission and/or configure applications and/or hosts (e.g., virtual machines). Examples of such services may include but are not limited to: data services, application services, security services, network services, connectivity services, business rules, legacy app orchestration, and the like. One or more of these services may be logically connected to one another. It should be noted that the master system platform module 120 may be logically centralized but physically distributed across one or more machines. In other implementations, it may be physically centralized in a machine such as a server. In some embodiments, communications within the master system 110 may be based on Ethernet or other suitable communication protocols. Communications between the master system 110 and the BAS 125 may be based on Ethernet, serial communication, or the like depending on the capability of the individual BAS. A plurality of protocols including MODBUS may be supported by the BAMS.

The BAMS based on an SDMS architecture enables functional coordination of sub-systems that would not be possible through legacy integration methods. As examples, two new functions that the disclosed master system facilitates: autonomous orchestration and autonomous optimization will be briefly described.

Autonomous orchestration: Given an issued command or query, the master system 110 can manage the implementation of the instruction(s) within the sub-systems to execute the command or query. In other words, the master system 110 enables a user to issue a high-level request and in response, manages the coordination and exchange of data among multiple sub-systems to achieve the outcome.

Autonomous Optimization: Given the available functions of the sub-systems, the master system 110 disclosed herein can self-adjust and self-regulate to optimize the performance of a smart building given a hierarchy of constraints (e.g., energy consumption, comfort, productivity, safety, etc.). In other words, the master system 110 enables a user to indirectly manipulate the sub-system controls by adjusting the balance of these constraints. For example, the master system 110 can provide feedback to the operator in the form of calculated impacts (e.g., risks) and trade-offs of the manipulation.

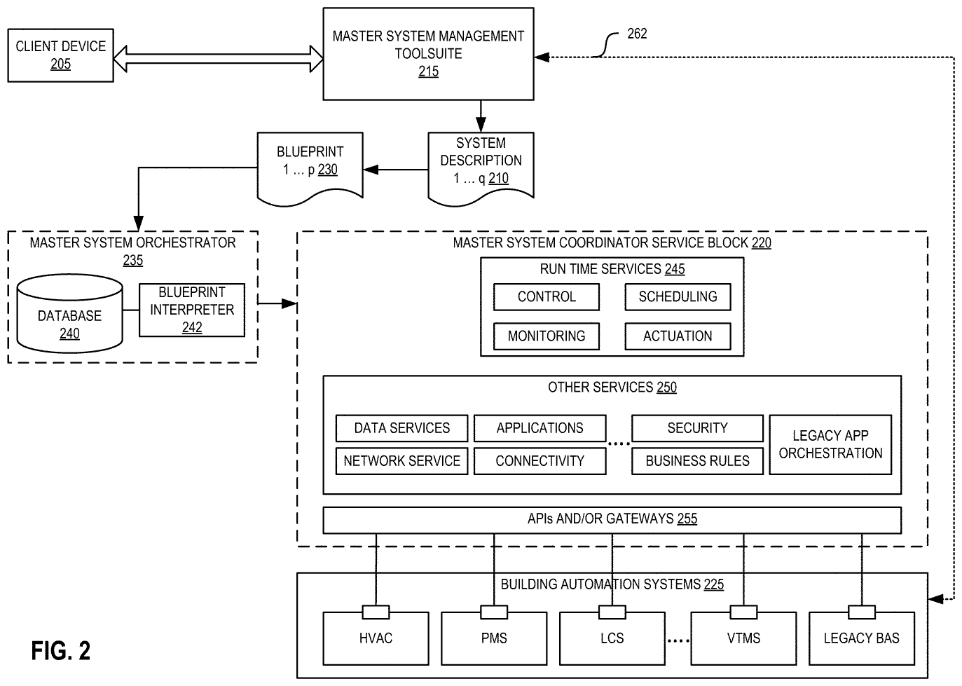

FIG. 2 is a block diagram detailing the logical architecture of the BAMS in accordance with some embodiments. The BAMS may support a plurality of different personas or users who may interact with the master system. Non-limiting examples include a specifier, a panel builder, a contractor, a facility operator, an administrator, and/or the like. A user may utilize the graphical user interface of the management system tool suite 215 to interact with the master system platform module 120. The user interactions may be related to system design and engineering, including, but not limited to: electrical, automation, mechanical and civil design for a smart building.

The management system tool suite 215 in some embodiments may be an integrated tool suite that comprises a plurality of software tools for lifecycle management and/or dynamic scheduling or coordination. The tool suite may provide functionalities related to design and engineering of various aspects of a smart building including but not limited to electrical, automation, mechanical and/or civil aspects. Specifically, the tool suite provides functionalities for engineering the building automation systems and the master system through the creation and deployment of building-related services. In some embodiments, design and engineering may involve defining system level exchanges (e.g., relating to data, networking, security, etc.) for the smart building through the master system services and the exposed BASs and associated asset capabilities. In some embodiments, the user command, query or request may be in the form of a workflow for a building related service.

The management system tool suite 215 may also provide capabilities that allow the user to define and/or apply business policies and system operational boundaries, dependencies and sequence of operations for initial system deployment and manage subsequent coordination between or among different BASs as part of orchestration design.

In some embodiments, the management system tool suite 215 may provide functionalities for enabling inter/intra operational systems dynamic interaction. This aspect of the management system tool suite 215 enables users to model dynamic interactions and perform coordination between operational systems (i.e., BASs) for autonomous or in some cases near-autonomous optimization and sub-system orchestration to implement a building-related service or functionality through the BAMS.

The output of the design and engineering activity is captured in a system description formalism 210. The system description can be of several types including, but not limited to: new system design, retrofits, extensions or related to dynamic system coordination. As used herein, a formalism represents a way to organize or represent information. A formalism may define or describe a syntax for structuring the information for representing the information. Non-limiting examples of formalisms include, but are not limited to: a table, a Unified Modeling Language (UML) diagram, XML, a mathematical equation, a chart, etc. The system description 210 may represent information relating to two aspects of a smart building: (i) lifecycle management and/or (2) dynamic system coordination.

Lifecycle management, in some embodiments, includes managing the lifecycle needs for a smart building, starting from the time it is specified (e.g., through a request for proposal), through configuration and deployment to decommissioning at the end of the lifecycle. In other words, lifecycle management includes management of all aspects of building systems and their evolutions (extensions, upgrades, retrofits, etc.). Dynamic system coordination, in some embodiments, includes runtime and dynamic scheduling to create a sequential flow of actions and/or events to implement a building-related service.

The system description 210 is transformed into a deployment-oriented system file called a blueprint 230. A blueprint 230 for a building-related service defines the system for implementing the building-related service. By way of example, a blueprint for a building-related service may include information about components (e.g., BASs, assets, hosts, services), their configurations, inter-connectivity with other components, and/or the like. If the system description 210 specifies q types, the blueprint 230 may be of p types. In other words, there may be different types of system descriptions corresponding to use cases, and hence different types of blueprints. Just as the system description, a blueprint may be stored in a data store with version control.

In some embodiments, a blueprint may comprise but is not limited to solution design and system level information exchanges between different BAS, information about the target platform(s) of deployment (e.g., IP addresses, MAC addresses, type of host, processing capabilities, operating system type, version, application software), dependencies to resolve (sequencing deployment actions on targets etc.), and/or the like. The blueprint can be defined by a plurality of existing declarative expression languages such as JSONATA.

The blueprint 230, being deployment oriented, serves one of two purposes: (1) lifecycle management for master system service(s) and/or for the other BAS components and (2) dynamic coordination or scheduling of events impacting multiple BAS. The blueprint 230 is consumed by the master system orchestrator 235 of the master system platform module.

A master system orchestrator 235 comprises of an interpreter 242 that consumes the blueprint 230 and converts it in an internal format that can be used by the services in the master system coordinator service bloc 220. A storage database 240 holds the orchestration flows, plugins, logs, etc. The master system coordinator service block 220, the master system orchestrator 235 and the set of APIs and/or gateways 255 together comprise the master system platform module 120. The APIs and/or gateways 255 enable the master system platform module 120 to interface with a plurality of BASs 225. When there is a change in the master system platform module 120, or when functionalities are added, updated and/or removed, the blueprint 230 and/or the system description 210 may be updated and stored in the data store as a new version.

The main role of the master system orchestrator 235 is to provide lifecycle management and dynamic coordination among a plurality of operational systems (i.e., BAS). The following include examples of aspects related to lifecycle management that the master system orchestrator may manage:
Software deployment—e.g., deployment of new applications, upgrades of previously deployed applications.
Configuration management—e.g., firmware updates, setting changes.
Infrastructure provisioning—e.g., compute, network, storage resources across the physical system infrastructure.
Monitoring—System and sub-systems monitoring and management, including cybersecurity.

The master system orchestrator 235 comprises a blueprint interpreter 242 and a storage database 240. The interpreter 242 consumes the blueprint 230 and converts it into an internal format (e.g., a machine-readable format) that is usable by other services. The storage database 230 may store information to be used at the time of deployment including orchestration flows, plugins, logs, and/or the like.

The coordinator service block 220 of the master system platform module 120 comprises a set of runtime services 245 relating to control, monitoring, scheduling and/or actuation. The coordinator service block 220 ensures dynamic coordination between a plurality of operational systems as specified in the blueprint 230. The control service may implement user level control strategies or algorithms related to system management and dynamic coordination of the smart building system functions (e.g., comfort control based on temperature, relative humidity and/or other parameters). The scheduling service may schedule an action or a sequence of actions to meet the user request or query. The monitoring service may monitor the master system services, including information related to the lifecycle and/or information related to the behaviors (e.g., manage event-based actions for frictionless entry/exist use case). The actuation service may act on the deployment plan, (e.g., to apply the coordination decisions).

In some embodiments, the other services 250 include software components of the master system software abstraction layer. The deployment of one or more of these services may be highly distributed with full cloud to edge orchestration. Hence, they form a part of the cloud-edge continuum and enable the operation of the master system software. Non-limiting examples of the services 250 are provided below.
Application services related to certain applications (e.g., EcoStruxure Advisors or Expert)
Data management services at cloud or edge to support applications
Connectivity service to provide end to end connectivity from the cloud to the BAS automation devices.
Network service to provide network resilience, fault tolerance and dynamic network re-configuration to support application needs
Security service to enforce cyber security from a system's perspective
Business rules or policies service to balance business objectives and system operations (e.g., occupant comfort).
Legacy application orchestration service to facilitate monitoring and control of legacy BAS.
Analytics service to gather and analyze data and identify and communicate patterns in data (not shown).

Typically, the master system orchestrator 235 can deploy all the services in the master system. In instances where an application is to be deployed on a BAS, and if that BAS is Internet of Things (IoT) capable, the master system can interact with a controller of the BAS for deployment. If the BAS is a legacy device, with limited or no IoT capability, the master system can instantiate the legacy application orchestrator to deploy the application.

The plurality of BASs comprises of a plurality of automation devices that act upon building processes related to electrical distribution, thermal, cooling, lighting, power generation (microgrids) and/or the like. The BASs provided by vendors/OEMs may be at different levels of maturity in their IOT ready system architectures. Consequently, there may be variation in the degree of exposure of their functional and non-functional capabilities.

The master system platform module 120 also includes a set of APIs and gateways 255 that enable the master system platform module 120 to interact or communicate with a plurality of BASs. Each BAS has one or more controllers that are involved in automation aspects. In some embodiments, gateways may act as protocol converters to translate non-ethernet-based protocols to ethernet-based protocols. IOT enabled BAS architectures provide standard and seamlessly integrable APIs to expose their capabilities and interact with the master system orchestrator and the plurality of other services of the master system. In some embodiments, legacy BAS may need some proprietary protocol conversions and physical gateway to expose their capabilities in order to interact with the master system orchestrator and plurality of other services of the master system.

In some embodiments, a communication link 262 may be provided between the management tool suite 215 and one or more of the plurality of BASs 225. The link may enable a BAS (e.g., legacy BAS that has no or limited IoT capability) to share context of configuration and functionalities with the management tool suite. In various embodiments, some aspects of the master system platform module 120 and/or the BASs may be implemented at the edge (i.e., closer to the assets or devices being controlled), while other aspects may be implemented on the cloud. In other words, the master system may be implemented in a logically centralized but physically distributed manner in some embodiments.

In some embodiments, the system description may be a dynamic object that has an associated learning component and/or is responsive to any detected optimization opportunities. In other words, as the master system learns of any optimization opportunities or detects a new functionality exposed by a BAS, then the master system feeds the information back to the management tool suite using the communication link 262 to enable updating of the system description. By way of example, if a new set of control settings is available, the master system may detect the availability of the new set of controls (e.g., through the monitoring service) and pass the information on to the management system tool suite to enable it to generate an updated system description if appropriate.

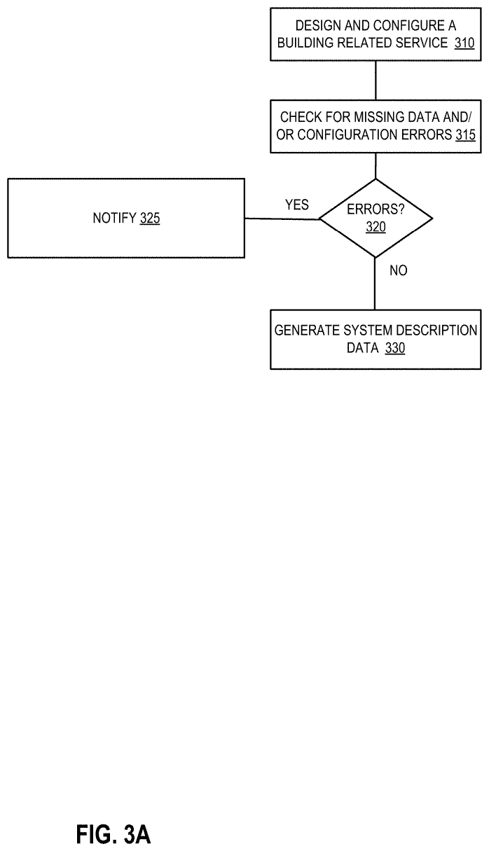

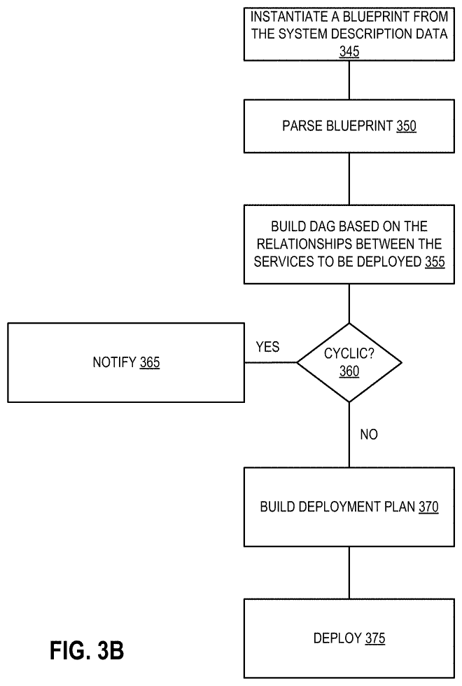

FIGS. 3A and 3B are logical flow diagrams illustrating a building-related service deployment flow in the BAMS in accordance with some embodiments.

Referring to FIG. 3A, the method starts with a user utilizing a graphical user interface of the management tool suite to design and configure a building related service at block 310. The building-related service may relate to lifecycle management or dynamic system coordination. In some implementations, the user may select a template for the specific use case related to the service as a starting point. In other implementations, the user may design the service from scratch. Creating the service from scratch may include selecting the type of service (e.g., lifecycle management, dynamic scheduling). Depending on the type of service selected, the user may select one or more BAS and one or more master system services. The user may also create data exchanges between the master system and one or more BASs, configure network, security and deployment targets (e.g., type of host, edge, cloud or local deployment), and/or other aspects.

At block 315, the management tool suite backend tool checks for any missing data and/or configuration errors. If there are any errors detected at block 320, the user is notified of those errors at block 325. If there are no errors, the management tool suite generates system description data for the building related service at block 330. In some implementations, the user may save the project without deploying the project as a building-related service.

Referring to FIG. 3B, in response to the user request to deploy the building-related service, a blueprint is instantiated from the system description data and provided to the master system orchestrator at block 345. The master system orchestrator parses blueprint at block 350. The master system orchestrator may use the information extracted from the blueprint to build a deployment plan comprising a sequence of steps and configurations for implementing the building-related service. The deployment plan may include identifying and resolving any service dependencies, determining a sequence for deploying one or more services, and one or more target hosts on which the one or more services are to be deployed. In some implementations, the master system orchestrator may identify and resolve any service dependencies by building a direct acyclic graphic (DAG) based on the relationships between the master system services to be deployed at block 355. If the master system orchestrator detects cyclicity in the DAG at decision block 360, it notifies the user that the deployment will not be allowed at block 365. In some embodiments, the master system orchestrator may suggest a corrective action to remedy the deployment error (e.g., change order of service execution to resolve the cyclicity issue). If the DAG is not cyclic, the master system orchestrator proceeds with building a deployment plan at block 370 and provides the deployment plan to the master system platform module for execution at block 375. The deployment plan as used herein comprises of a sequence of actions/steps, configurations, and/or services related to the deployment of the building-related service. A deployment plan associated with a dynamic coordination type of building related service may include a sequence of actions (e.g., services, API calls to one or more BAS) to be executed in response to detecting of one or more events to implement the building-related service. A deployment plan associated with a lifecycle management type of building related service may include a set of steps to be taken during deployment of the building related service. For example, when upgrading a software application of a BAS, some of the steps may include retrieving application installation package, selecting compute nodes, provisioning resources (e.g., hosts, data storage), configuring network and security, and the like.

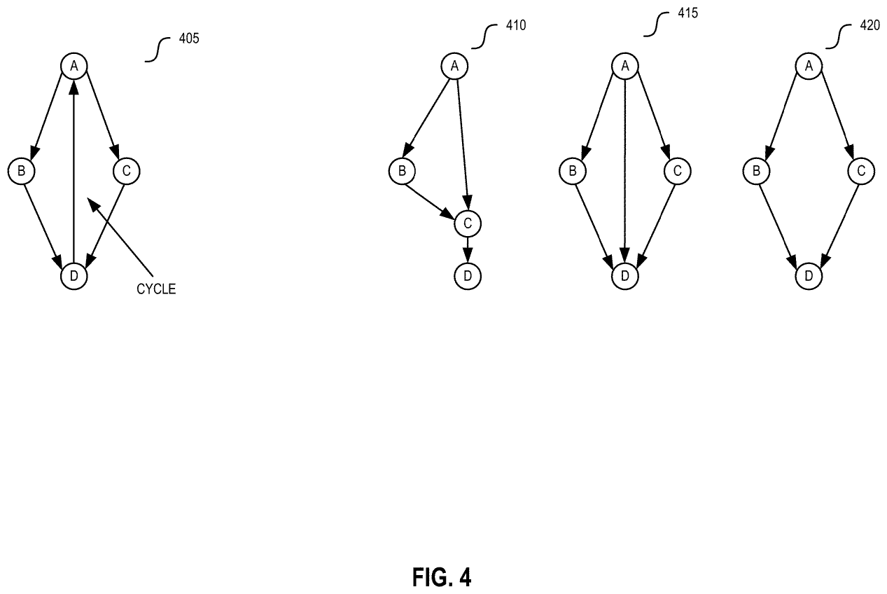

FIG. 4 is a diagram illustrating service dependencies in the BAMS in accordance with some embodiments. The DAG 405 shows a service deployment sequence where service A is deployed first, followed by B or C and then D. However, service A requires service D creating an infinite loop. In this instance, the master system orchestrator determines that the DAG 405 is cyclic. In each of the DAG 410, DAG 415 and DAG 420, the graph direction is uni-directional and service D requires services A, B and C. In this instance, the master system orchestrator determines that DAG is acyclic (i.e., not cyclic).

### Example 1: A Building-Related Service for Facilitating an Effortless Entry/Exit

One example of a building-related service that involves dynamic coordination and that can be configured and deployed in the BAMS of a smart building is an effortless entry/exit system. Such a system can provide a way for employees, visitors, delivery persons, maintenance persons, and the like to a secure and speedy access to a building (or areas of a building) without requiring badges or barriers. An authentication mechanism (e.g., facial recognition) may be a prerequisite for implementing the effortless entry/exit system.

To provide such an effortless entry/exit experience, a well-coordinated operation of different sub-systems that are configured to act based on an orchestrated set of operations is needed. The BAMS makes the coordinated operation not only possible, but also more efficient. In this example, a worker, customer, sub-contractor etc., may enter and navigate an office building in a manner that still manages security and safety but with a minimum of interruption, confusion and manual intervention. In this people traffic management scenario, people can get to where they need to be as fast as is possible with little stress and overall, the mass of people who go in and out of a building can be optimized.

Consider a company “InvestToGrow” that is going to welcome high level business delegates from their strategic client “Happy Semiconductors”. To deliver a frictionless access experience for the visitors, the following sub-systems functions and user roles may need to be coordinated during the visit of the client.

| | |
|---|---|
| User roles (e.g., via | Happy Semiconductors: visitor 1, visitor 2 |
| mobile interface) | InvestToGrow: strategic account executive, |
| | facility manager |
| External system services | Taxi finding apps, Google maps, Local |
| | transportation |
| Entry/exit physical | Dedicated barrierless lanes to facilitate fast |
| systems | movement |
| Elevator system (VTMS) | Dedicated elevators for visitors |
| Lighting system (LCS) | Way finding for access to meeting rooms, |
| | auditoriums, restaurants, etc. |
| Mobile app based | Used by the host to create the schedule for |
| experience creation | visit |

The following is an example of interactions that may take place in order to enable autonomous orchestration and dynamic coordination to achieve a frictionless experience for the visitors.
A user (e.g., the strategic account executive) opens an application (e.g., management tool suite) to create a new building-related service or project. The service or project may be created based on an existing template for customer visit. The user creates new profiles (or uses pre-existing ones) for the delegates and plans the entire visit in the system. Examples of a set of actions and configurations in a workflow for the building-related service created using the application may include:
   a. Configure specific actions:
      i. Date, time and length of visit, including related reminders appropriately spaced in time.
      ii. Information related to transportation (e.g., public transport, taxi service, etc.)
      iii. Enable use of a mobile device as a boarding pass to avail services and accessibility within the building perimeter (includes parking spaces, and inside building maneuvers).
   b. Building sub-system actions:
      i. Dedicate parking spaces.
      ii. Authenticate and authorize entry to the premise, dedicated areas, auditoriums etc.
      iii. Designate elevator numbers for the visitors.
      iv. Adjust HVAC and lighting settings to provide the most ambient environment settings during work, while eating at a restaurant or while inside the auditorium.
The user specifies the entire workflow, saves the project and deploys the project to the master system.

The master system of the BAMS can maintain the global context of the building sub-systems and based on business policies and system operational perimeters can allow a precise coordination of the different sub-system functions to realize the configured project objectives of a stress-free movement. Some of the benefits include time saved for the user organizing the visit, optimized people traffic flows, enhanced security (i.e., right people to the right places), easier identification of anomalies and appropriately addressed and enhanced experience.

In various embodiments, the frictionless entry/exit experience may be limited by the variety and level of sophistication of the sub-systems that the master system has access to. The master system may capture the feedback from the different sub-systems and feed it to its analytics services block to close the experience feedback loop and propose enhancement actions to the human actors as well as to the sub-systems.

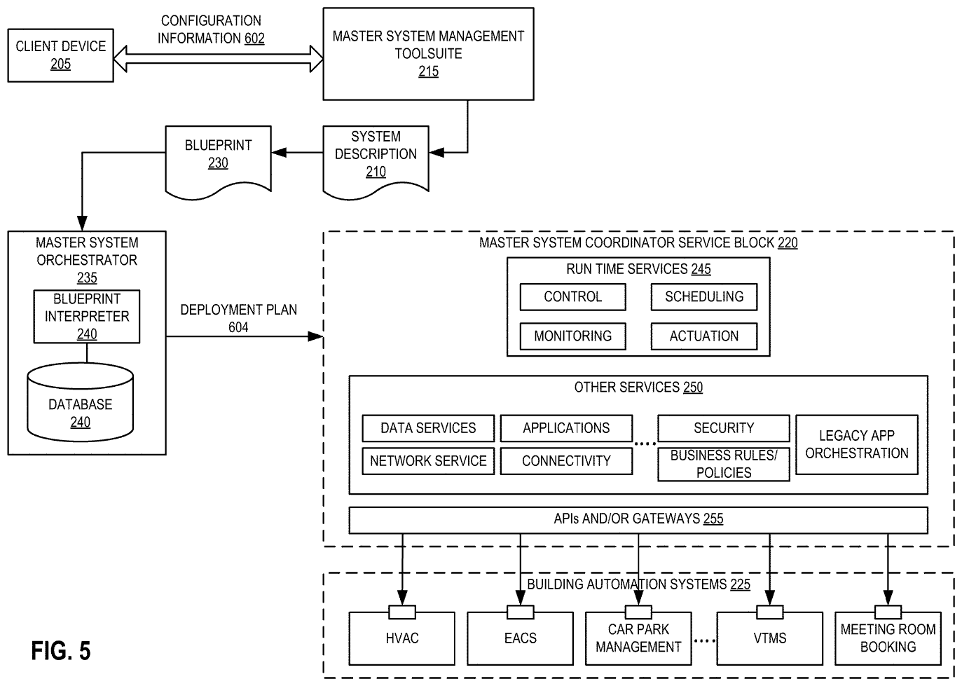

FIG. 5 is a logical architecture flow diagram illustrating flow of information through the BAMS to provide integrated scheduling and dynamic coordination for implementing a building-related service for facilitating effortless entry/exit in accordance with some embodiments.

A user using a client device 205 to access a graphical user interface of an application of the management tool suite 215 creates a workflow relating to a customer's on-site visit. One of the steps the user takes in creating the workflow may include inputting details relating to the visit, such the visitor name(s), physical address(es), mobile number(s), email address(es), date of visit, time of visit, information on person(s) being visited, reason for visit and/or the like. The user may then configure some specific actions for the master system to perform. Some specific actions associated with a customer's on-site visit example may include: an action to send a communication about the visit to the visitor(s) and the person(s) being visited. Another action may include retrieving information related to public transportation (e.g., schedule), taxi/ride sharing service, directions and the like and including the information in the communication sent to the visitor(s). Yet another example may include selecting a boarding pass device or means (e.g., mobile device, card) to obtain access to the building and/or specific areas of the building and/or services (e.g., cafeteria, printing). Various other actions may be specified.

The next set of actions that the user may configure may be building sub-system actions. In this example, the relevant sub-systems may include the room reservation system, the car park management system, the electronic access control system, the VTMS and the HVAC system. Each of these sub-systems may expose functionality and/or data through APIs and/or gateways 255. The user may configure actions corresponding to the exposed functionality and/or data. In this example, the user may configure the room reservation system to reserve a meeting room, the park management system to allocate a parking spot, the electronic access control system to authenticate and authorize entry of the visitor(s) to the building, dedicated building areas, meeting rooms, etc., the VTMS to designate elevator numbers for use by the visitor(s), and the HVAC system to automatically adjust HVAC, lighting and/or blinds settings (e.g., in the meeting room) for optimal comfort and/or authorize the visitor's mobile phone to adjust the HVAC, lighting and/or blind settings. In some implementations, the user may configure the sequence in which these actions are to be executed. In other implementations, the user may utilize a template for the customer visit use case, in which case, the sequence of actions would be predetermined. In some implementations, the user may also configure other settings relating to underlying infrastructure such as network, security, data storage, hosts, and/or the like. The user may then save the project (i.e., building-related service).

When the project is saved, the application backend services tool uses the user provided configuration information 602 to generate system description data 210 (e.g., in an extensible markup language format) associated with the building-related service The system description data 210 may include sub-system data exchanges such as data exchanges between the master system and the associated BAS (i.e., HVAC, LCS, VTMS, EACS, car park management and meeting room booking).

The system description data 210 may also include additional information such as notifications and alerts, result of the workflow dependency checks, and the like. The system description data 210 may be stored in data storage along with the project (not shown). When the project is updated, new system description data 210 may be generated and stored in data storage (e.g., as a new version). When ready, the user may deploy the project to the master system.

The backend services tool also performs checks on the workflow to detect any errors. By way of example, the master system management tool suite 215 may check for missing or incorrect configurations such as missing data exchanges between BAS, missing network information, missing security configurations, and the like. If there are any errors, the user is notified.

The system description data is used by the master system management tool suite 215 to instantiate a blueprint 214 (e.g., in JSONATA) for the building-related service. The master system orchestrator 235 receives the blueprint 214 and parses it to extract information that it needs to sequence deployment actions on target hosts. The blueprint interpreter 240 may extract information relating to data exchanges between different BAS and/or the master system, information about target hosts for deployment, dependencies to resolve, and the like. The blueprint 214 may be stored in data storage 240. The blueprint interpreter 240 may also check for any dependencies that could lead to deployment failure. If there are no dependencies or when the dependencies are resolved (e.g., automatically or by user action), the master system orchestrator 235 generates a deployment plan 604 and provides it to the master system coordinator service block 220. The master system coordinator service block 220 in turn coordinates deployment actions/steps and applies configurations as specified in the deployment plan on the various sub-systems and manages the plan in the event of any failures. Specifically, the master system coordination service block 220, based on the deployment plan, instantiates a plurality of services in a distributed manner across edge and cloud layers. By way of example, the master system coordinator service 220 instantiates the scheduling service to implement a schedule for instantiating one or more services. These services may include the system services (i.e., run-time services 245 and other services 250) as well as non-system services (e.g., actions involving the BASs). The monitoring service is instantiated to monitor for one or more events specified in the deployment plan. The monitoring service may also monitor the functioning of the different services including the system services and non-system services that are specified in the deployment plan. Actuation service may be triggered by one or more events to execute the actions specified in the deployment plan. As part of executing the deployment plan, the master system coordinator service block 220 (e.g., via the scheduling services) communicates with each BAS associated with the building-related service as follows:
the car park management system via an API to request a parking spot for the period of the visit and receives from the system a reserved parking spot number and/or location.
the electronic access control system via an API to obtain authorization for the customer to enter/exit the building premises during the period of the visit.
the VTMS via an API to request an elevator number authorized for use by the customer.
the meeting room booking system via an API to request a meeting room for the period of the visit.
the HVAC system via an API to obtain authorization to adjust temperature settings of a room controller using the customer's mobile device or application.

Information about visit including the building location, parking location/spot, meeting room, etc. may be sent to the user and/or the customer prior to the visit (e.g., via a notification service). Once a customer for whom the on-site visit was configured arrives on site and checks in (via guest registration tablet, manual check in at reception), the electronic access control system may authenticate the customer as an authorized visitor and provide electronic access to the building (e.g., actuation service). Successful authentication of the customer and access authorization triggers the VTMS to authorize the customer to use the elevator A (e.g., via actuation service). The customer may be directed to the meeting room, or the user may be alerted to receive the customer at the waiting area (e.g., notification service). Electronic access to the meeting room may be granted based on an authentication means (e.g., facial recognition, mobile device proximity) (e.g., via actuation service). The room controller in the meeting room may be configured to authorize the customer to use his or her mobile device to adjust the room environment (e.g., temperature, lighting, blinds, etc.) (e.g., via actuation service). In this way, the BAMS facilitates dynamic coordination of multiple BASs to provide a frictionless entry/exit experience without the user or the customer having to take any extra steps beyond the initial design and creation of the workflow.

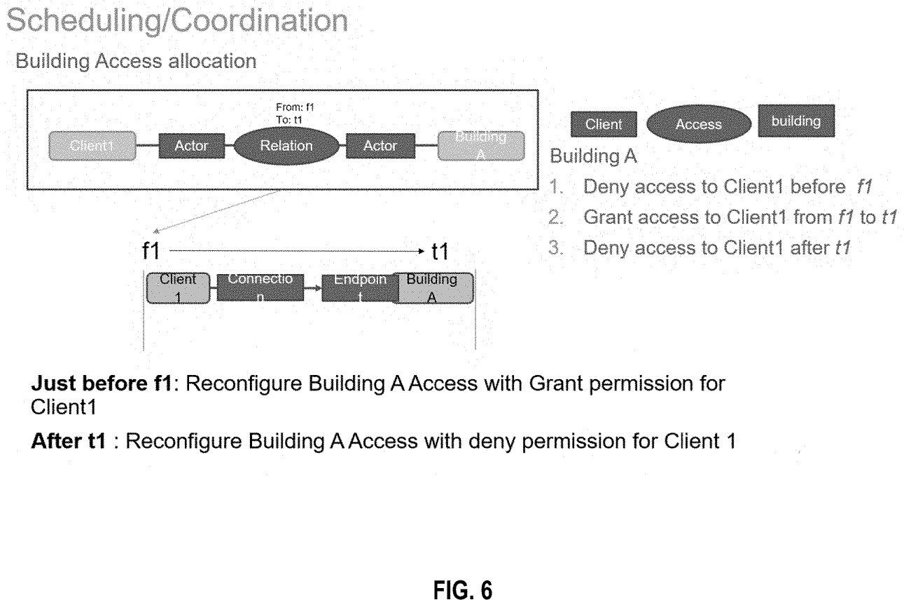

FIG. 6 includes graphs illustrating details of the scheduling and coordination aspects for providing access to a building in accordance with some embodiments. As shown, an actor: client 1 may have a relationship with another actor: building A. The relationship can be an “access” type relationship. The relationship can be granted for a period of time (f1−t1) such that before f1, client 1 is denied access and after t1, access is revoked so that client 1 is once again denied access.

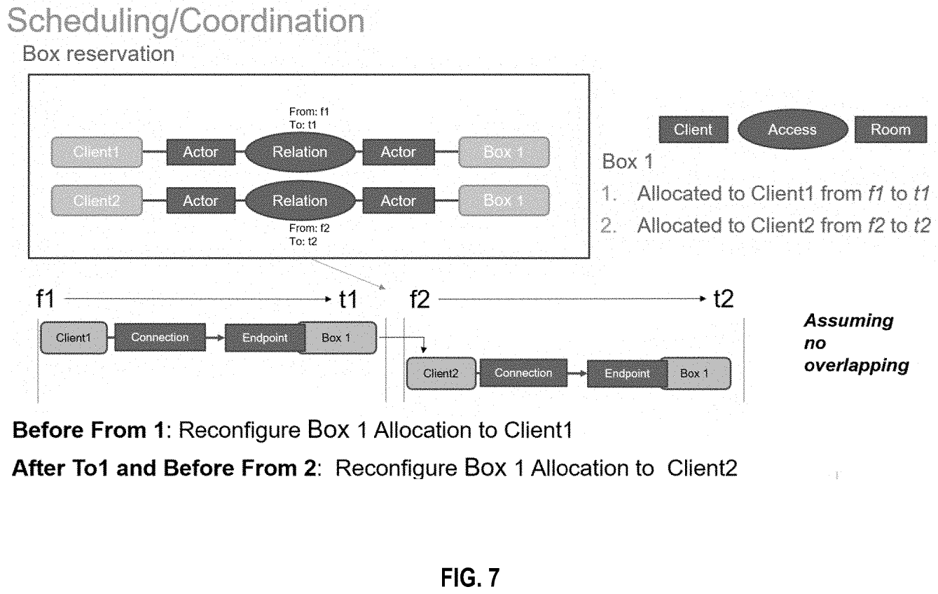

Similarly, FIG. 7 includes graphs illustrating details of a room (box) reservation associated with scheduling and coordination aspects for providing access to a building in accordance with some embodiments. Client 1 has an access type relationship with box 1 and client 2 also has an access type relationship with box 1. However, the relationship has a temporal aspect in that box 1 is allocated to client 1 from f1 to t1 and to client 2 from f2 to t2.

### Example 2: Autonomous Optimization of Energy Efficiency and Occupant Comfort

One of the objectives of a smart building is to optimize efficiency by balancing the potentially competing demands of the need for energy efficiency of the building with the comfort of the occupants. For this use case, the goal of optimization may be to balance the variables of energy efficiency and comfort given several additional constraints at a given point in time. At times of low or no occupancy it is relatively easy to turn-off lights, limit the movement of elevators or escalators, and adjust the environmental controls to favor a low energy mode state. Similarly, at peak occupancy, these same sub-systems can be set to full function to favor comfort and mobility. Optimization, however, requires the coordination of the variety of available sub-systems given the variation of energy usage and occupancy over the life cycle of the building.

For example, consider a very warm day where high levels of air-conditioning are typically required to make the building comfortable enough to work and be productive in. These exceptionally hot days tend to also increase demands on city transit systems, so many people may choose to work from home, and they create high electrical demand, which can stress the electricity grid infrastructure, so the city may request that the buildings try to limit electrical consumption to keep from exceeding capacity.
The power grid system operator reports a peak demand forecast owing to the increased energy consumption from city transit system and the residential buildings.
The system operator informs the city electrical distribution utility of a critical price warning.
The electrical distribution utility operator informs a smart building operator of an imminent electricity price increase and the demand response scenario is executed.

In existing buildings, the operator of the building would interact with a number of sub-systems to evaluate the current status of each and then, after some level of analysis, take some combination of decisions to take digital or manual interventions to turn off lights, limit the number of active lifts, adjust cooling temperature setpoints, and so on to achieve a desired reduction in consumption. While some level of automation of these actions is possible, the trade-offs of these decisions are made with a limited number of data points from a number of separate data source sub-systems and often without detailed insights into the full implications of the potential consequences of each change except, perhaps, the intuition of a very experienced human building operator.

A BAMS based on SDMS, however, has awareness of the current state of each sub-system and, given that many of these sub-systems may be virtualized or could be virtualized (e.g., as digital twin), and can combine and analyze data for the building as a whole to calculate and recommend the optimum settings to create the largest possible energy reduction given the current and projected state of need, including feedback from the occupants as to their comfort and level of annoyance to the inconveniences, before implementing any changes. The human operator may then select from several offered scenarios and give the master system of the BAMS, the instruction to implement some number of control instructions to the individual sub-systems. The changes and the impacts of the changes may be monitored and tweaked over time to autonomously maintain the balance within certain defined boundaries. The level to which the building may be optimized may be limited by the variety and level of sophistication of the sub-systems that the master system is in communication with. The master system may become more capable as new sub-systems are introduced or upgraded with new functionalities.

Simultaneous to these internal optimizations, the master system may also receive and analyze data from external systems related to the cost/benefit elements of the decisions (including an automatic calculation of efficiency related renewable energy credits), gain feedback from the city relative to the current status of the success or elevated risk to the electrical grid given the response (or lack of) by other grid connected energy consumers, and evaluate the options to utilize any available renewable energy microgrid capacity or stored energy for the benefit of the building or to export to the grid. Some of the benefits of using BAMS to autonomously optimize efficiency and comfort include improvement of “green” ratings (for audit and market valuation purposes), benefit from government subsidies, easy access to credit, reduced disruption to occupants, enhanced experience and “brand value.”

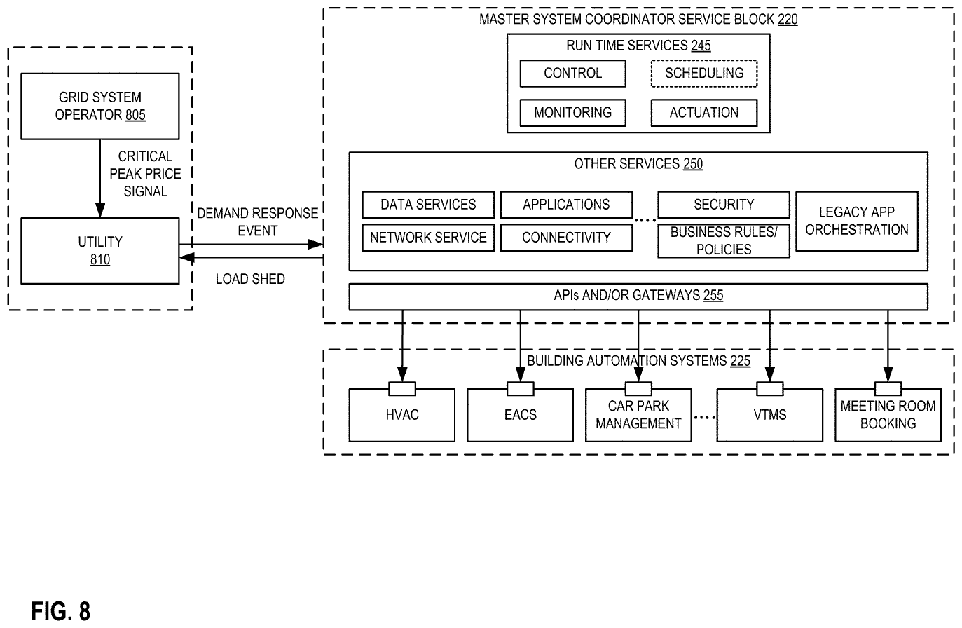

FIG. 8 is a logical architecture flow diagram illustrating flow of information through the BAMS to provide dynamic coordination to achieve autonomous optimization of energy efficiency and occupant comfort in a smart building in accordance with some embodiments.

A smart building implementing SDMS and participating in a demand response program offered by its utility provider can autonomously optimize one or more building performance parameters such as occupant comfort while responding to a demand response event.

In some embodiments, a power grid system operator 805 issues a critical peak price signal to an electrical distribution utility 810. The utility 810, in turn, generates an automated message to indicate a demand response event. The BAMS of the smart building may receive the automated message indicating the demand response event. In response to the event, the master system coordinator service 220 may invoke one or more services to reduce energy consumption while optimizing occupant comfort.

In some implementations, the master system coordinator service block 220 may invoke the business rules/policies service to obtain one or more rules or policies associated with managing the demand response event. One example of a rule or policy may be to automatically participate in demand response during the hours of 2:00 p.m. to 5:00 p.m. Another rule may be to participate in demand response outside of the hours of 2:00 pm to 5:00 with a facility manager's authorization. With the decision is to participate in demand response, the master system coordinator service 220 may invoke the control service to implement an algorithm for curtailing specific pre-determined loads while optimizing for occupant comfort. The algorithm may utilize the monitoring service for monitoring one or more parameters relating to energy, occupancy, temperature, and the like. The algorithm may further utilize the actuation service to interact with one or more BASs to control one or more parameters. For example, the actuation service may interact with the HVAC system to control the temperature (e.g., increase temperature set point if in cooling mode, decrease temperature set point if in heating mode) and the LCS to turn off lighting based on occupancy data. In some implementations, the data on the energy and environment parameters may be obtained from applications such as Schneider Electric's EcoStruxure Building Advisor, Power Advisor, and the like.

### Example 3: Configuring, Commissioning and Installation a Microgrid System in a Smart Building

The software defined concept can be extended to any automation system. An example could be to configure, commission and install a microgrid system in a smart building. A user (e.g., a panel builder) may use a microgrid build tool (e.g., available from the master system management tool suite 215) to create a project. The user may select templates of distributed energy resources (DERs) such as solar, wind and/or battery storage and perform configuration actions. Examples of such configuration actions may include configuring settings, operational characteristics and setting up data exchanges between the DERs and the master system. The user may then select the infrastructure for deploying the on-site control and cloud-based energy management. When the user saves the project, a system description file associated with the project is created. Further, a blueprint may be instantiated from the saved system description. The blueprint being a deployment-oriented file may comprise, in addition to the system description data, information about the system configuration, information about the target hosts and dependencies to resolve before deploying applications on the hosts. During the deployment phase, the master system orchestrator consumes the blueprint and instantiates the required applications (e.g., protection function, Schneider Electric's EcoStruxure Advisor applications, demand response management, optimization algorithm) and services (e.g., services related to managing connectivity, network redundancy, and the like) on the designated targets.

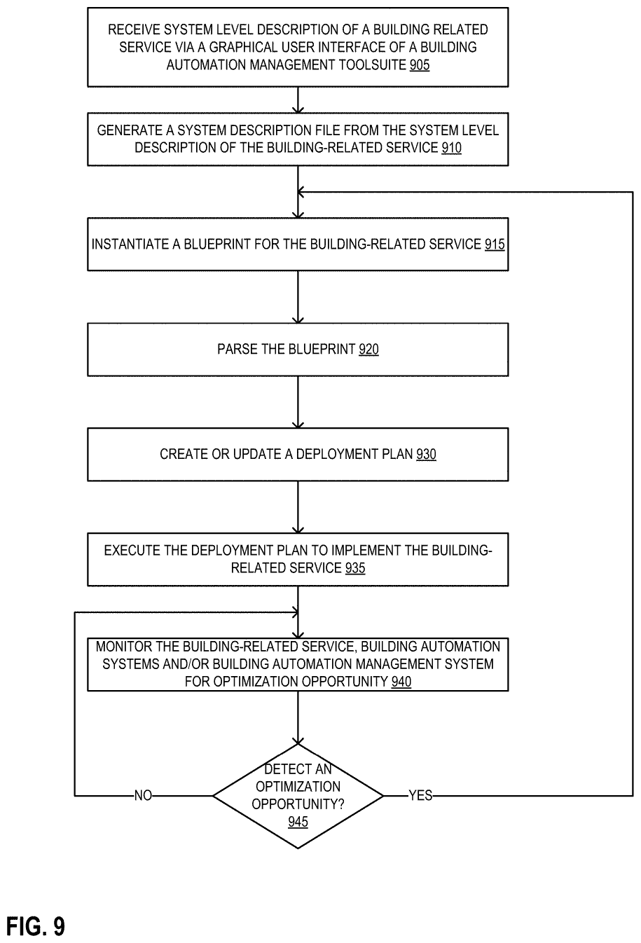

FIG. 9 is a logical flow diagram illustrating a method of implementing a building-related service in a BAMS in accordance with some embodiments.

At 905, the master system 110 receives system level description of a building-related service. In some implementations, the system level description of the building-related service may include a workflow comprising a set of actions and configurations defining the building-related service. The building-related service may be designed and deployed by a user via a graphical user interface of the building management tool suite 215. The building-related service may involve dynamic coordination between at least two BASs.

At 910, the master system 110 (e.g., via the building management tool suite 215) generates system description data (e.g., a file) from the system level description of the building-related service. At block 915, the master system 110 instantiates, from the system description data, a blueprint for the building-related service. In some implementations, the blueprint may define data exchanges with the at least two BASs, and include information about target hosts, and any dependencies to be resolved.

At block 920, the master system (e.g., via the master system orchestrator 235) parses the blueprint to resolve any dependencies (e.g., to determine a sequence of steps or deployment actions). At block 930, the master system 110 creates (or updates in some instances) a deployment plan that includes a sequence of steps and configurations for implementing the building-related service. The deployment plan may be created based on information extracted from the blueprint by parsing. In some implementations, the deployment plan may include information identifying components of the building-related service (e.g., services, actions, and/or events, and the like), resources produced and/or consumed by each component, sequence in which the components are to be created and/or executed, data exchanges between the components, target hosts for deployment, and/or the like.

At block 935, the BAMS executes the deployment plan to implement the building-related service. Executing the deployment plan may include executing the sequence of steps and configurations to achieve dynamic coordination between the at least two BASs. Some examples of steps and configurations may include instantiating one or more services on one or more target hosts as well as provisioning and commissioning the underlying infrastructure in order to enable the master system of the BAMS to orchestrate monitoring and/or control of one or more assets associated with the BASs to implement the building-related service.

In some embodiments, at block 940, the BAMS (via the master system module) monitors the building-related service, BASs and/or the BAMS for optimization opportunity. At decision block 945, if an optimization opportunity is detected, the BAMS may generate a new blueprint at block 915 to take advantage of the optimization opportunity.

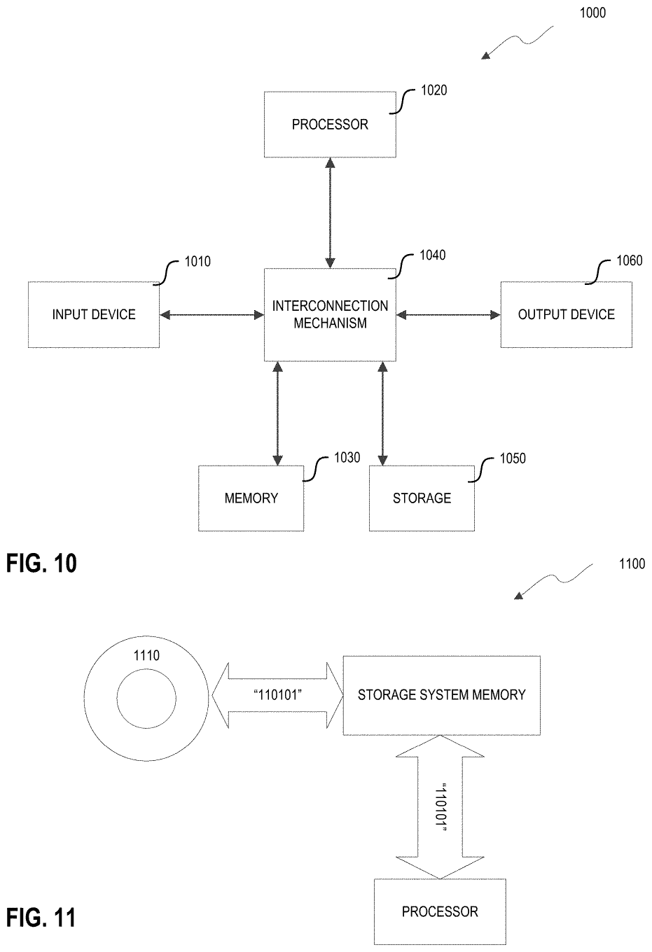

FIG. 10 illustrates an exemplary computing system that may be used to implement various embodiments of this disclosure. In general, any general-purpose computer systems used in various embodiments of this disclosure may be, for example, general-purpose computers such as those based on Intel® Pentium-type processor, Motorola® PowerPC, Sun® UltraSPARC®, Hewlett-Packard® PA-RISC processors, or any other type of processor. Such computer systems may be either physical or virtual.

For example, various embodiments of the disclosure may be implemented as specialized software executing in a general-purpose computer system 1000 such as that shown in FIG. 10. The computer system 1000 may include a processor 1020 connected to one or more memory devices 1030, such as a disk drive, memory, or other device for storing data. Memory 1030 is typically used for storing programs and data during operation of the computer system 1000. The computer system 1000 may also include a storage system 1050 that provides additional storage capacity. Components of computer system 1000 may be coupled by an interconnection mechanism 1040, which may include one or more busses (e.g., between components that are integrated within the same machine) and/or a network (e.g., between components that reside on separate discrete machines). The interconnection mechanism 1040 enables communications (e.g., data, instructions) to be exchanged between system components of system 1000.

Computer system 1000 also includes one or more input devices 1010, for example, a keyboard, mouse, trackball, microphone, touch screen, and one or more output devices 1060, for example, a printing device, display screen, speaker. In addition, computer system 1000 may contain one or more interfaces (not shown) that connect computer system 1000 to a communication network (in addition or as an alternative to the interconnection mechanism 1040).

The storage system 1050, shown in greater detail in FIG. 11, typically includes a computer readable and writeable nonvolatile recording medium 1110 in which signals are stored that define a program to be executed by the processor 1020 or information stored on or in the medium 1110 to be processed by the program to perform one or more functions associated with embodiments described herein. The medium may, for example, be a disk or flash memory. Typically, in operation, the processor 1020 causes data to be read from the nonvolatile recording medium 1110 into storage system memory 1120 that allows for faster access to the information by the processor than does the medium 1110. This storage system memory 1120 is typically a volatile, random access memory such as a dynamic random-access memory (DRAM) or static memory (SRAM). This storage system memory 1120 may be located in storage system 1050, as shown, or in the system memory 1030. The processor 1020 generally manipulates the data within the memory system 1120 and then copies the data to the medium 1110 after processing is completed. A variety of mechanisms are known for managing data movement between the medium 1110 and the integrated circuit memory element 1120, and the disclosure is not limited thereto. The disclosure is not limited to a particular memory 1120, memory 1030 or storage system 1050.

The computer system may include specially programmed, special-purpose hardware, for example, an application-specific integrated circuit (ASIC). Aspects of the disclosure may be implemented in software, hardware or firmware, or any combination thereof. Further, such methods, acts, systems, system elements and components thereof may be implemented as part of the computer system described above or as an independent component.

Although computer system 1000 is shown by way of example as one type of computer system upon which various aspects of the disclosure may be practiced, it should be appreciated that aspects of the disclosure are not limited to being implemented on the computer system as shown in FIG. 10. Various aspects of the disclosure may be practiced on one or more computers having a different architecture or components shown in FIG. 10. Further, where functions or processes of embodiments of the disclosure are described herein (or in the claims) as being performed on a processor or controller, such description is intended to include systems that use more than one processor or controller to perform the functions.

Computer system 1000 may be a general-purpose computer system that is programmable using a high-level computer programming language. Computer system 1000 may be also implemented using specially programmed, special purpose hardware. In computer system 1000, processor 1020 is typically a commercially available processor such as the well-known Pentium class processor available from the Intel Corporation. Many other processors are available. Such a processor usually executes an operating system which may be, for example, the Windows 95, Windows 98, Windows NT, Windows 2000, Windows ME, Windows XP, Vista, Windows 7, Windows 10, or progeny operating systems available from the Microsoft Corporation, MAC OS System X, or progeny operating system available from Apple Computer, the Solaris operating system available from Sun Microsystems, UNIX, Linux (any distribution), or progeny operating systems available from various sources. Many other operating systems may be used.

The processor and operating system together define a computer platform for which application programs in high-level programming languages are written. It should be understood that embodiments of the disclosure are not limited to a particular computer system platform, processor, operating system, or network. Also, it should be apparent to those skilled in the art that the present disclosure is not limited to a specific programming language or computer system. Further, it should be appreciated that other appropriate programming languages and other appropriate computer systems could also be used.

In the preceding, reference is made to various embodiments. However, the scope of the present disclosure is not limited to the specific described embodiments. Instead, any combination of the described features and elements, whether related to different embodiments or not, is contemplated to implement and practice contemplated embodiments. Furthermore, although embodiments may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

It will be appreciated that the development of an actual commercial application incorporating aspects of the disclosed embodiments will require many implementation specific decisions to achieve a commercial embodiment. Such implementation specific decisions may include, and likely are not limited to, compliance with system related, business related, government related and other constraints, which may vary by specific implementation, location and from time to time. While a developer's efforts might be considered complex and time consuming, such efforts would nevertheless be a routine undertaking for those of skill in this art having the benefit of this disclosure.

It should also be understood that the embodiments disclosed and taught herein are susceptible to numerous and various modifications and alternative forms. Thus, the use of a singular term, such as, but not limited to, “a” and the like, is not intended as limiting of the number of items. Similarly, any relational terms, such as, but not limited to, “top,” “bottom,” “left,” “right,” “upper,” “lower,” “down,” “up,” “side,” and the like, used in the written description are for clarity in specific reference to the drawings and are not intended to limit the scope of the invention.

This disclosure is not limited in its application to the details of construction and the arrangement of components set forth in the following descriptions or illustrated by the drawings. The disclosure is capable of other embodiments and of being practiced or of being carried out in various ways. Also, the phraseology and terminology used herein is for the purpose of descriptions and should not be regarded as limiting. The use of “including,” “comprising,” “having,” “containing,” “involving,” and variations herein, are meant to be open-ended, i.e., “including but not limited to.”

The various embodiments disclosed herein may be implemented as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer-readable medium(s) having computer-readable program code embodied thereon.

Any combination of one or more computer-readable medium(s) may be utilized. The computer-readable medium may be a non-transitory computer-readable medium. A non-transitory computer-readable medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer-readable medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages. Moreover, such computer program code can execute using a single computer system or by multiple computer systems communicating with one another (e.g., using a local area network (LAN), wide area network (WAN), the Internet, etc.). While various features in the preceding are described with reference to flowchart illustrations and/or block diagrams, a person of ordinary skill in the art will understand that each block of the flowchart illustrations and/or block diagrams, as well as combinations of blocks in the flowchart illustrations and/or block diagrams, can be implemented by computer logic (e.g., computer program instructions, hardware logic, a combination of the two, etc.). Generally, computer program instructions may be provided to a processor(s) of a general-purpose computer, special-purpose computer, or other programmable data processing apparatus. Moreover, the execution of such computer program instructions using the processor(s) produces a machine that can carry out a function(s) or act(s) specified in the flowchart and/or block diagram block or blocks.

One or more portions of the computer system may be distributed across one or more computer systems coupled to a communications network. For example, as discussed above, a computer system that determines available power capacity may be located remotely from a system manager. These computer systems also may be general-purpose computer systems. For example, various aspects of the disclosure may be distributed among one or more computer systems configured to provide a service (e.g., servers) to one or more client computers, or to perform an overall task as part of a distributed system. For example, various aspects of the disclosure may be performed on a client-server or multi-tier system that includes components distributed among one or more server systems that perform various functions according to various embodiments of the disclosure. These components may be executable, intermediate (e.g., IL) or interpreted (e.g., Java) code which communicate over a communication network (e.g., the Internet) using a communication protocol (e.g., TCP/IP). For example, one or more database servers may be used to store device data, such as expected power draw, that is used in designing layouts associated with embodiments of the present disclosure.

It should be appreciated that the disclosure is not limited to executing on any particular system or group of systems. Also, it should be appreciated that the disclosure is not limited to any particular distributed architecture, network, or communication protocol.

Various embodiments of the present disclosure may be programmed using an object-oriented programming language, such as SmallTalk, Java, C++, Ada, or C# (C-Sharp). Other object-oriented programming languages may also be used. Alternatively, functional, scripting, and/or logical programming languages may be used, such as BASIC, Fortran, Cobol, TCL, or Lua. Various aspects of the disclosure may be implemented in a non-programmed environment (e.g., analytics platforms, or documents created in HTML, XML or other format that, when viewed in a window of a browser program render aspects of a graphical-user interface (GUI) or perform other functions). Various aspects of the disclosure may be implemented as programmed or non-programmed elements, or any combination thereof.

The flowchart and block diagrams in the Figures illustrate the architecture, functionality and/or operation of possible implementations of various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be understood that the above description is intended to be illustrative, and not restrictive. Many other implementation examples are apparent upon reading and understanding the above description. Although the disclosure describes specific examples, it is recognized that the systems and methods of the disclosure are not limited to the examples described herein but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

We claim:

1. A method of implementing a building-related service in a building automation management system (BAMS) comprising a plurality of building automation systems (BASs), the method comprising:
receiving a request to create a building-related service involving dynamic coordination between at least two BASs, the request including a workflow comprising a set of actions and configurations defining the building-related service;
generating, from the workflow, system description data;
instantiating, from the system description data, a blueprint for the building-related service, the blueprint defining data exchanges with the at least two BASs, information about target hosts, and any dependencies to be resolved;
parsing the blueprint to resolve any dependencies;
building a deployment plan that includes a sequence of steps and configurations for implementing the building-related service; and
executing the deployment plan to implement the building-related service.

2. The method of claim 1 wherein the building-related service is one of a lifecycle management service or a dynamic scheduling service.

3. The method of claim 1 further comprising: detecting an optimization opportunity;
and in response, updating at least one of the system description or the blueprint to optimize the building-related service.

4. The method of claim 1, wherein the request is received from a user via a graphical user interface of a building automation management system tool suite.

5. The method of claim 1, further comprising checking for any missing data and/or configuration errors in the workflow.

6. The method of claim 1, further comprising applying a template having at least a subset of the actions and configurations preconfigured to create the building-related service.

7. The method of claim 2, wherein the building-related service is one of: providing frictionless entry/exit or providing autonomous optimization of energy efficiency and occupant comfort.

8. The method of claim 7, further comprising:
receiving from a user, via a graphical user interface of a building automation management system tool suite, the workflow for the frictionless entry/exit, wherein the configurations in the workflow includes one or more of: building information, visitor identifying information, visitor preference information, scheduling information, or hospitality information; and
dynamically identifying, based on information in the workflow, the at least two BASs and the set of operations and/or services involved in executing the dynamic scheduling service to configure the frictionless entry/exit.

9. The method of claim 8, wherein the at least two BASs involved in performing the dynamic scheduling service to configure the frictionless entry/exit comprises at least two of: (a) an access control system to authenticate a visitor and provide access to one or more areas of a building, (b) HVAC system to control environmental conditions to optimize comfort and/or air quality (c) a light and blinds control system to control lighting and operation of blinds, (d) a transportation system or (e) external service(s)/system(s).

10. A building automation management system (BAMS), comprising:
a master system;
a plurality of building automation systems (BASs);
a set of APIs and/or gateways for connecting the master system with each of the plurality of BASs;
wherein the master system further comprises:
a master system orchestration module executing on one or more machines, and configured to:
receive a blueprint associated with a building-related service defined by a user, the building-related service involving dynamic coordination between at least two BASs facilitated by one or more APIs and/or gateways;
wherein the blueprint defines data exchanges with the at least two BASs, information about target hosts, and any dependencies to be resolved;
parse the blueprint to resolve any dependencies;
build a deployment plan comprising a sequence of steps and configurations for implementing the building-related service; and
a master system coordinator service executing on one or more machines, and configured to:
execute the deployment plan to implement the building-related service.

11. The BAMS of claim 10, wherein the master system further comprises a management tool suite providing a graphical user interface for defining the building-related service.

12. The BAMS of claim 11, wherein the management tool suite is further configured to check for any missing data and/or configuration errors in the workflow.

13. The BAMS of claim 10, wherein the building-related service is one of a lifecycle management service or a dynamic scheduling service.

14. The BAMS of claim 10, wherein the building-related service is one of: providing frictionless entry/exit or providing autonomous optimization of energy efficiency and occupant comfort.

15. The BAMS of claim 10, wherein the master system is further configured to detect an optimization opportunity, and in response, update at least one of the system description or the blueprint to optimize the building-related service.

16. A non-transitory computer-readable medium storing one or more programs comprising instructions which when executed by a machine, cause the machine to:
receive a request to create a building-related service involving dynamic coordination between at least two BASs, the request including a workflow comprising a set of actions and configurations defining the building-related service;
generate, from the workflow, system description data;
instantiate, from the system description data, a blueprint for the building-related service, the blueprint defining data exchanges with the at least two BASs, information about target hosts, and any dependencies to be resolved;
parse the blueprint to resolve any dependencies;
build a deployment plan that includes a sequence of steps and configurations for implementing the building-related service; and
execute the deployment plan to implement the building-related service.

17. The non-transitory computer-readable medium of claim 16, wherein the master system further comprises a management tool suite providing a graphical user interface for defining the building-related service.

18. The non-transitory computer-readable medium of claim 17, wherein the management tool suite is further configured to check for any missing data and/or configuration errors in the workflow.

19. The non-transitory computer-readable medium of claim 16, wherein the building-related service is one of a lifecycle management service or a dynamic scheduling service.

20. The non-transitory computer-readable medium of claim 16, wherein the building-related service is one of: providing frictionless entry/exit or providing autonomous optimization of energy efficiency and occupant comfort.

21. The non-transitory computer-readable medium of claim 16, wherein the master system is further configured to detect an optimization opportunity, and in response, update at least one of the system description or the blueprint to optimize the building-related service.
